(19) United States
(12) Patent Application Publication
(10) Pub. No.: US 2021/0118621 A1
(43) Pub. Date: Apr. 22, 2021

(54) MODULAR INTEGRATED STORED POWER SYSTEMS INCLUDING A STORED ENERGY MODULE

(71) Applicant: Advanced Technology Applications Group Inc., Las Cruces, NM (US)

(72) Inventor: Joshua KAUFFMAN, Las Cruces, NM (US)

(21) Appl. No.: 17/072,513

(22) Filed: Oct. 16, 2020

Related U.S. Application Data
(60) Provisional application No. 62/923,328, filed on Oct. 18, 2019.

(51) Int. Cl. H01G 11/06; H01G 11/78; H01M 10/0525; H01M 4/58

(52) U.S. Cl. CPC H01G 11/06; H01M 4/5825; H01M 10/0525; H01G 11/78

(57) ABSTRACT

Articles and methods regarding energy storage systems, particularly integrated energy storage systems. In certain embodiments, the integrated energy storage systems may be modular in nature and may comprise one or more stored energy modules, such as an electrochemical stored energy module, an electrostatic stored energy module, or a combination thereof.

### CROSS-REFERENCE TO RELATED APPLICATION(S)

This application claims priority under 35 U.S.C. § 119(e) to U.S. Provisional Patent Application No. 62/923,328, entitled “MODULAR INTEGRATED STORED POWER SYSTEMS INCLUDING A STORED ENERGY MODULE,” filed Oct. 18, 2019, naming inventor Joshua KAUFFMAN, which is assigned to the current assignee hereof and incorporated herein by reference in its entirety.

### FIELD OF THE DISCLOSURE

The disclosure generally relates to articles and methods regarding energy storage systems, particularly integrated energy storage systems. In certain embodiments, the integrated energy storage systems may be modular in nature and may comprise one or more stored energy modules, such as an electrochemical stored energy module, an electrostatic stored energy module, or a combination thereof.

### BACKGROUND

Electrical energy storage refers to the process of converting electrical energy into a stored form that can later be converted back into electrical energy when needed. Batteries have been the principal devices used for electrical energy storage but they continue to have various limitations and drawbacks. Therefore, there continues to bee a need for improved energy storage products and methods

### BRIEF DESCRIPTION OF THE DRAWINGS

The present disclosure may be better understood, and its numerous features and advantages made apparent to those skilled in the art by referencing the accompanying drawings.

FIG. 1A is an illustration of a side view (height and width) of an energy storage module according to an embodiment.

FIG. 1B is an illustration of another side view (height and length) of an energy storage module according to an embodiment.

FIG. 2 is an illustration showing a perspective view of an integrated stored power system according to an embodiment.

FIG. 3 is an image of a discharge curve for an energy storage module according to an embodiment.

The use of the same reference symbols in different drawings indicates similar or identical items.

### BRIEF DESCRIPTION

Integrated stored power systems and their constituent elements are described herein. In an embodiment, an integrated stored power system may comprise a waterproof and shock-proof system. In some embodiments, an integrated stored power system may comprise a plurality of smaller individual energy storage modules that, when combined in parallel, form a singular individual integrated stored power system. In some embodiments, an integrated stored power system comprises that the plurality of smaller individual energy storage modules are mounted in a protective surrounding framework, such as a chassis. Embodiments of integrated stored power systems can utilize higher power and higher capacity than comparative systems. In an embodiment, each smaller individual energy storage module may comprise having enough capacity and power to perform within an operational window of a specified application but at one third the capacity of the total combined modular system. This enables an integrated stored power system to continue functioning even in the event of failure of an individual energy storage module and allows for replacement of one or more individual energy storage modules during the failure event. The substitution of an individual energy storage module, as well as the integration of multiple individual energy storage modules into an integrated stored power system is expedient and requires no tooling. In addition, in some embodiments, an integrated stored power system may comprise a “hybrid system” wherein the individual energy storage modules may comprise electrochemical batteries, capacitor units, micro fuel cells, or combinations thereof. In some embodiments, the substitution of a supercapacitor energy storage module into the integrated stored power system may increase the total available energy capacity.

### DETAILED DESCRIPTION

The following description, in combination with the figures, is provided to assist in understanding the teachings disclosed herein. The following discussion will focus on specific implementations and embodiments of the teachings. This discussion is provided to assist in describing the teachings and should not be interpreted as a limitation on the scope or applicability of the teachings.

The term “averaged,” when referring to a value, is intended to mean an average, a geometric mean, or a median value. As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but can include other features not expressly listed or inherent to such process, method, article, or apparatus. As used herein, the phrase “consists essentially of” or “consisting essentially of” means that the subject that the phrase describes does not include any other components that substantially affect the property of the subject.

Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Further, references to values stated in ranges include each and every value within that range. When the terms “about” or “approximately” precede a numerical value, such as when describing a numerical range, it is intended that the exact numerical value is also included. For example, a numerical range beginning at “about 25” is intended to also include a range that begins at exactly 25. Moreover, it will be appreciated that references to values stated as “at least about,” “greater than,” “less than,” or “not greater than” can include a range of any minimum or maximum value noted therein.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and can be found in textbooks and other sources within the electrical energy storage, battery, and capacitor arts.

Present embodiments provide unexpected advantages, properties, benefits, and solutions to problems related to electrical energy storage systems. Embodiments of the present invention provide modular high capacity, high powered, low maintenance power supply using lithium based battery power systems designed to perform with the utilization of smaller individual battery systems that when combined form into a singular higher power and higher capacity battery platform. The utilization of smaller power systems enables redundancy, uniformity and expandability and addresses the need for a complete power transformation that is field expedient and requires no tooling.

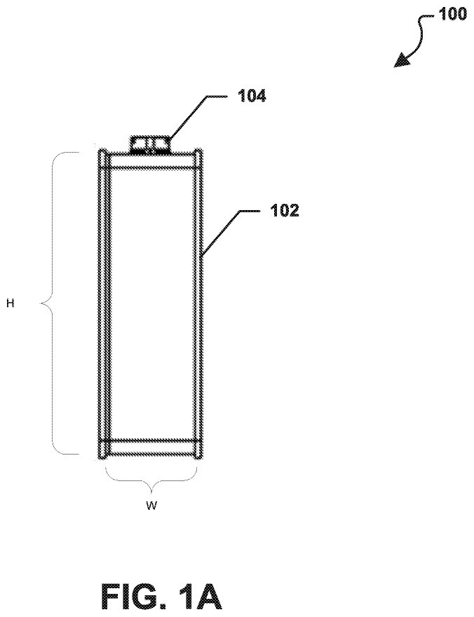

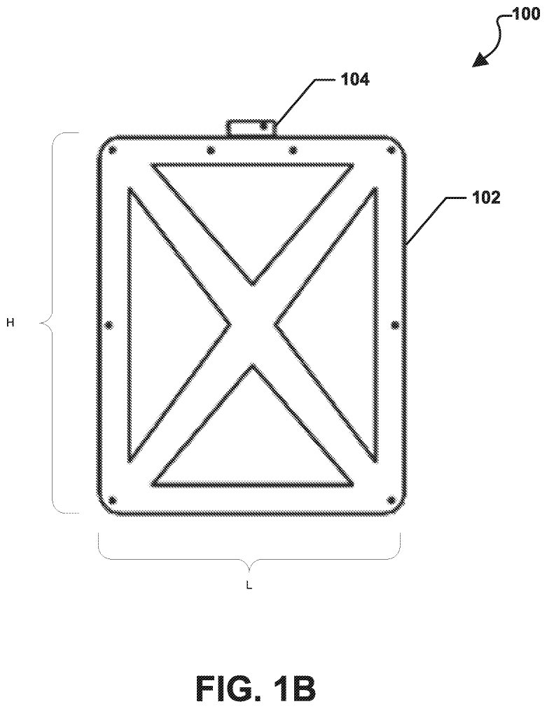

FIGS. 1A and 1B are illustrations of side views of an energy storage module 100 according to an embodiment. In an embodiment, the energy storage module 100 may comprise a coulometric capacity of at least 1.5 amp hours to not greater than 150 amp hours at a discharge rate of 26.4 V DC. In specific embodiments, the a coulometric capacity may comprise at least 30 amp hours, at least 40 amp hours, or at least 50 amp hours at a discharge rate of 26.4V DC. In an embodiment, the stored energy module 100 may further comprise a Max Pulse Discharge of 1000 amps. In specific embodiments, the Max Pulse Discharge may comprise a cycle life of at least one second to not greater than 10 seconds at a 150 amp discharge. In certain embodiments, the stored energy module 100 may comprise a coulometric capacity of 50 amp hours at a discharge rate of 26.4 V DC and a Max Pulse Discharge of 1000 amps per cycle life of at least 10 seconds at a 150 amp discharge.

The stored energy module 100 may further comprise an energy storage cell (not visible) disposed inside a housing 102. In certain embodiments, the stored energy module 100 may comprise a plurality of energy storage cells disposed inside the housing 102. In an embodiment, the energy storage cell may comprise an electrochemical composition. In an embodiment, the electrochemical composition may comprise a lithium composition. In an embodiment, the lithium composition may comprise a phosphate moiety, an iron moiety, or a combination thereof. In specific embodiments, the lithium composition may comprise a lithium iron phosphate (LiFePO4) moiety. In certain embodiments, the energy storage cell (not visible) disposed inside the housing 102 may comprise an electrostatic storage element. In an embodiment, the electrostatic storage element may comprise a capacitor. In certain embodiments, the capacitor may comprise a double layer capacitor (also known as a super capacitor or ultra capacitor). In certain embodiments, the energy storage cell disposed in the housing 102 may comprise a cylindrical cell, a prismatic cell, a pouch cell, or a combination thereof. In an embodiment, a plurality of energy storage cells is disposed in the housing 102 and may comprise a cylindrical cell, a prismatic cell, a pouch cell, or a combination thereof.

In a specific embodiment, the stored energy module 100 may be adapted to prevent and/or minimize thermal runaway. In an embodiment, the stored energy module 100 may include a thermal runaway prevention system. In an embodiment, the thermal runaway prevention system may comprise a cell-to-cell protection, a module-to-module protection, a battery pack level protection, or a combination thereof. In an embodiment, the thermal protective system may comprise a phase-change material. In an embodiment, the thermal protective system may comprise active thermal management, passive thermal management, or a combination thereof. In an embodiment, the thermal runaway prevention system may comprise a temperature sensor, a thermal conducting film, a thermal insulating film, a coolant, a coolant circulator, an energy cell interconnect interrupt, or a combination thereof.

In certain embodiments, the housing 102 may further comprise a connector 104. In an embodiment, the connector may comprise a high amp connector, a charge connector, a maintenance connector, or a combination thereof.

As shown in FIGS. 1A and 1B, in an embodiment, the energy storage module 100 may have a specific height (“H”), width (“W”) (also referred to herein as a “thickness”), and a length (“L”). In an embodiment, the height (“H”) may be at least 0.5 in., such as at least 1 in., at least 2 in., at least 3 in., at least 4 in., at least 5 in., or at least 6 in. In an embodiment, the height may be not greater than 65 in., such as not greater than 55 in., not greater than 45 in., not greater than 35 in., not greater than 30 in., or not greater than 28 in. The height can be within a range comprising any pair of the previous upper and lower limits. In a particular embodiment, the height may be at least 0.5 in. to not greater than 65 in., such as at least 6 in. to not greater than 40 in. In an embodiment, the width (“W”) may be at least 0.25 in., such as at least 0.5 in., at least 1 in., at least 1.5 in., at least 2 in., at least 2.5 in., or at least 3 in. In an embodiment, the width may be not greater than 25 in., such as not greater than 20 in., not greater than 15 in., not greater than 12 in., not greater than 10 in., or not greater than 8 in. The width can be within a range comprising any pair of the previous upper and lower limits. In a particular embodiment, the width may be at least 0.25 in. to not greater than 25 in., such as at least 1 in. to not greater than 10 in. In an embodiment, the length (“L”) may be at least 0.5 in., such as at least 1 in., at least 2 in., at least 3 in., at least 4 in., at least 5 in., or at least 6 in. In an embodiment, the length may be not greater than 55 in., such as not greater than 45 in., not greater than 35 in., not greater than 25 in., not greater than 20 in., or not greater than 15 in. The length can be within a range comprising any pair of the previous upper and lower limits. In a particular embodiment, the length may be at least 0.5 in. to not greater than 55 in., such as at least 5 in. to not greater than 35 in. In a specific embodiment, the energy storage module 100 may comprise dimensions of 6 to 24 in. (H) by 2 to 10 in. (W) by 5 to 24 in. (L).

In an embodiment, the energy storage module 100 may have a specific volume. In an embodiment, the volume may be at least 1 in.³, such as at least 10 in.³, at least 60 in.³, at least 75 in.³, at least 200 in.³., or at least 500 in.³ In an embodiment, the volume may be not greater than 75,000 in.³, such as not greater than 40,000 in.³, not greater than 18,000 in.³, not greater than 10,000 in.³, not greater than 5,000 in.³, or not greater than 1,000 in.³ The volume can be within a range comprising any pair of the previous upper and lower limits. In a particular embodiment, the volume may be at least 1 in.³ to not greater than 20,000 in.³, such as at least 75 in.³ to not greater than 5,000 in.³

In an embodiment, the energy storage module 100 may have a specific weight. In an embodiment, the weight may be at least 0.5 lb., such as at least 1 lb., at least 2 lb., at least 3 lb., at least 4 lb., at least 6 lb., or at least 8 lb. In an embodiment, the weight may be not greater than 30 lb., such as not greater than 28 lb., not greater than 24 lb., not greater than 22 lb., not greater than 20 lb., or not greater than 18 lb. The weight can be within a range comprising any pair of the previous upper and lower limits. In a particular embodiment, the weight may be at least 0.5 lb. to not greater than 30 lb., such as at least 1 lb. to not greater than 20 lb.

As previously stated, the energy storage module 100 may have a specific coulometric capacity. In an embodiment, the coulometric capacity is at least 1.5 amp hours to not greater than 150 amp hours at a discharge rate of 26.4 V DC. In an embodiment, the coulometric capacity may be at least 1.5 amp hours, such as at least 3.0 amp hours, at least 6.0 amp hours, at least 12 amp hours, at least 24 amp hours, at least 30 amp hours, at least 40 amp hours, or at least 50 amp hours at a discharge rate of 26.4V DC. In an embodiment, the coulometric capacity may be not greater than 150 amp hours, such as not greater than 125 amp hours, not greater than 100 amp hours, not greater than 90 amp hours, not greater than 80 amp hours, or not greater than 75 amp hours at a discharge rate of 26.4V DC. The coulometric capacity can be within a range comprising any pair of the previous upper and lower limits. In a particular embodiment, the coulometric capacity may be at least 1.5 amp hours to not greater than 150 amp hours at a discharge rate of 26.4V DC, such as at least 30 amp hours to not greater than 90 amp hours at a discharge rate of 26.4V DC.

In an embodiment, the energy storage module 100 may have a specific power output. In an embodiment, the power output may be at least 1,000 W/kg., such as at least 2,000 W/kg., at least 3,000 W/kg., at least 5,000 W/kg., at least 7,500 W/kg., at least 10,000 W/kg., or at least 15,000 W/kg. In an embodiment, the power output may be not greater than 45,000 W/kg., such as not greater than 50,000 W/kg., not greater than 40,000 W/kg., not greater than 35,000 W/kg., not greater than 30,000 W/kg., or not greater than 25,000 W/kg. The power output can be within a range comprising any pair of the previous upper and lower limits. In a particular embodiment, the power output may be at least 1,000 W/kg. to not greater than 50,000 W/kg., such as at least 10,000 W/kg. to not greater than 40,000 W/kg.

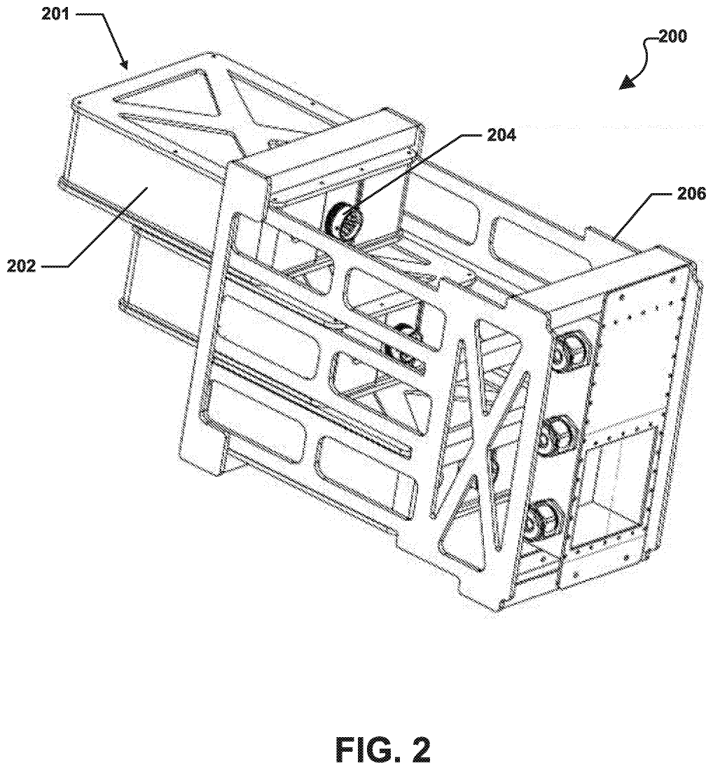

FIG. 2 shows a perspective view of an integrated stored power system 200. In an embodiment, an integrated stored power system 200 may comprise a coulometric capacity of at least 50 amp hours to not greater than 1000 amp hours at a discharge rate of 26.4 V DC. In certain embodiments, integrated stored power system 200 may comprise at least 100 amp hours, at least 150 amp hours, at least 200 amp hours, at least 250 amp hours, or at least 300 amp hours. In an embodiment, the integrated stored power system 200 may further comprise a Max Pulse Discharge of at least 2000 amps, such as at least 3000 amps, or at least 4000 amps. In certain embodiments, the Max Pulse Discharge is per a cycle life of at least one second to not greater than 10 seconds at a 150 amp discharge. In a specific embodiment, the stored power system 200 may comprise a coulometric capacity of 150 amp hours at a discharge rate of 26.4 V DC and a Max Pulse Discharge of 3000 amps per cycle life of at least 10 seconds at a 150 amp discharge.

The integrated stored power system 200 may comprise an energy storage module 201, or a plurality of energy storage modules 201 disposed in a support framework 206 (also referred to herein as a “chassis” or “rack”). The energy storage module 201 may comprise a housing 202 and a connector 204. In certain embodiments, the stored power system 200 may comprise a plurality of stored energy modules, such as at least 2 stored energy modules, or at least 3 stored energy modules. In an embodiment, the stored energy modules 201 may be connected in parallel, in series, or a combination thereof. In a specific embodiment, the stored energy modules 201 may be connected in parallel.

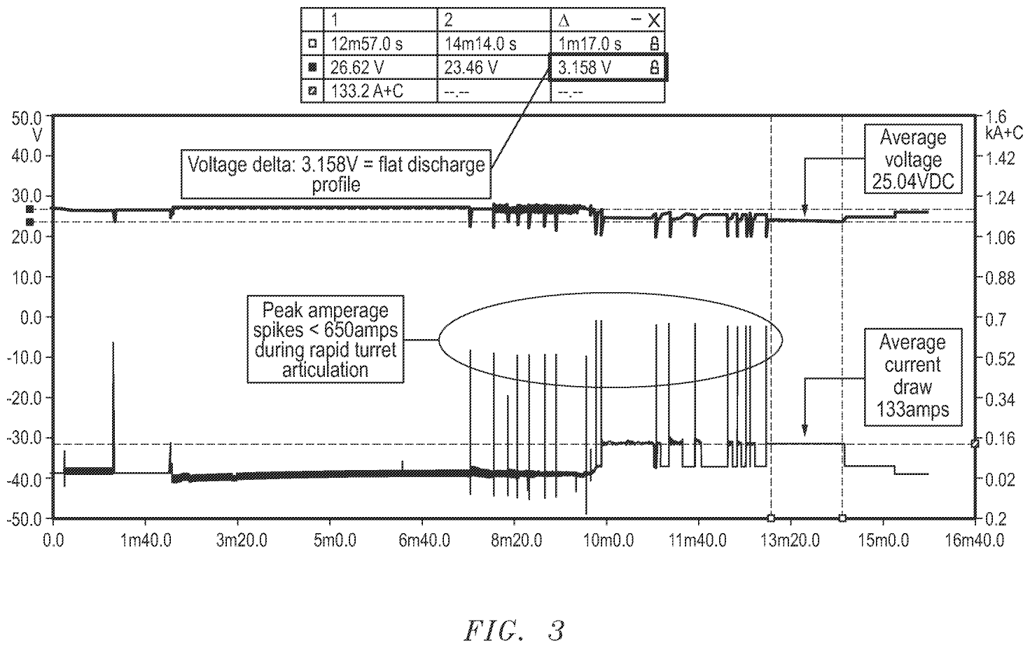

In an embodiment, an energy storage module 100 or a stored power system 200 may be adapted to produce a flat discharge curve that is inversely proportional to the state of charge in the energy storage module 100 or the stored power system 200. In an embodiment, the energy storage module 100 or a stored power system 200, may comprise a discharge profile comprising a change in voltage (voltage delta) that is not greater than 20% of the average voltage during discharge, such as not greater than 18%, not greater than 16%, not greater than 15%, not greater than 14%, or not greater than 13% of the average voltage during discharge. In an embodiment, the energy storage module 100 or a stored power system 200 may comprise a discharge profile comprising a peak amperage spike of not greater than 600% of the average current draw, such as not greater than 550%, not greater than 500%, not greater than 495%, or not greater than 490% of the average current draw. FIG. 3 shows is an image of a discharge curve for an energy storage module according to an embodiment.

In an embodiment, each individual power module has enough capacity and power to perform within the operational window of the specified application but at one third the capacity of the total large singular power system. Advantageously, this capability to continue power supply within an operational widow enables a user to continue operations in the event of battery failure due to damage or substitution.

As used herein, in an embodiment, a plurality of fully integrated individual energy storage modules (“module(s)”) comprise a larger singular integrated stored power system (“storage power system”). In specific embodiments, a storage power system may comprise at least one module, two modules, three modules, or combinations thereof. In an embodiment, the module or modules may be replaceable and substitutable. In an embodiment, each individual module may comprise a 50 Amp hour battery that when joined in parallel becomes the larger singular storage power system. In an embodiment, the storage power system may further comprise a single superstructure, such as a framework or chassis, that is adapted to hold the modules and facilitates parallel connection of the modules without tools or cable rerouting. In an embodiment, the superstructure may be designed around a cassette assembly. In an embodiment, the superstructure may fully surround and/or encapsulate the individual modules. In an embodiment, the superstructure may provide not only protection to the modules, but also allow for the function of a storage power system even at partial capacity. This means that in the event of one or more failures of the individual power modules, the larger storage power system can still function as a whole with partial total capacity.

In an embodiment, both the modules and the storage power system can comprise 24 Volt DC systems. In an embodiment, both the modules and the storage power system can comprise quick coupling (disconnect/connect) high amperage connectors that allow for tool-less coupling and decoupling without the risk of dead shorting/fault due to exposed terminals. In an embodiment, this advantageously removes all guess work and risk experienced by an end user and allows the rapid replacement or expansion of the individual power modules and integrated storage power system as a whole. In an embodiment, the lack of exposed terminal design greatly limits the corrosion in harsh environments, increases dependability, and reduces maintenance costs.

In an embodiment, the power storage system may comprise optional interface accessories that allow for an individual power system to support multiple equipment platforms or to be used as a standalone support when additional power and capacity may be required.

In an embodiment, the power modules and storage power system may comprise a passive system for maintenance and charging. In a specific embodiment, a passive system may include a charger and a maintainer system for both platforms.

In an embodiment, charge maintenance protocol is passive, which means all charging happens after completion of activity when the battery is plugged into the charger system by the end user and the passive management charging will return the battery to 100 percent the state-of-charge, enabling low cost reliability and ease of use but requires end user interface and maintenance schedule.

### Embodiments

Embodiment 1. A stored energy module comprising: a coulometric capacity of at least 1.5 amp hours to not greater than 150 amp hours at a discharge rate of 26.4 V DC, such as at least 30 amp hours, at least 40 amp hours, or at least 50 amp hours at a 26.4V DC.

Embodiment 2. The stored energy module of embodiment 1, further comprising a Max Pulse Discharge of 1000 amps.

Embodiment 3. The stored energy module of embodiment 2, wherein the Max Pulse Discharge is per a cycle life of at least one second to not greater than 10 seconds at a 150 amp discharge.

Embodiment 4. The stored energy module of embodiment 3, comprising a coulometric capacity of 50 amp hours at a discharge rate of 26.4 V DC and a Max Pulse Discharge of 1000 amps per cycle life of at least 10 seconds at a 150 amp discharge.

Embodiment 5. The stored energy module of embodiment 1, further comprising an energy storage cell disposed inside a housing.

Embodiment 6. The stored energy module of embodiment 5, wherein a plurality of energy storage cells are disposed inside the housing.

Embodiment 7. The stored energy module of embodiment 5, wherein the energy storage cell comprises an electrochemical composition.

Embodiment 8. The stored energy module of embodiment 7, wherein the electrochemical composition comprises a lithium composition.

Embodiment 9. The stored energy module of embodiment 8, wherein the lithium composition comprises a phosphate moiety, an iron moiety, or a combination thereof.

Embodiment 10. The stored energy module of embodiment 9, wherein the lithium composition comprises a lithium iron phosphate (LiFePO4).

Embodiment 11. The stored energy module of embodiment 5, wherein the energy storage cell comprises an electrostatic storage element.

Embodiment 12. The stored energy module of embodiment 11, wherein the electrostatic storage element is a capacitor.

Embodiment 13. The stored energy module of embodiment 12, wherein the capacitor is a double layer capacitor.

Embodiment 14. The stored energy module of embodiment 5, wherein the energy storage cell is a cylindrical cell, a prismatic cell, a pouch cell, or a combination thereof.

Embodiment 15. The stored energy module of embodiment 6, wherein the plurality of energy storage cells comprise a cylindrical cell, a prismatic cell, a pouch cell, or a combination thereof.

Embodiment 16. The stored energy module of embodiment 15, wherein the stored energy module is adapted to prevent and/or minimize thermal runaway.

Embodiment 17. The stored energy module of embodiment 16, including a thermal runaway prevention system.

Embodiment 18. The stored energy module of embodiment 17, wherein the thermal runaway prevention system comprises a cell-to-cell protection, a module-to-module protection, a battery pack level protection, or a combination thereof.

Embodiment 19. The stored energy module of embodiment 18, wherein the thermal runaway prevention system comprises a phase-change material.

Embodiment 20. The stored energy module of embodiment 18, wherein the thermal runaway prevention system comprise active thermal management, passive thermal management, or a combination thereof.

Embodiment 21. The stored energy module of embodiment 18, wherein the thermal runaway prevention system comprises a temperature sensor, a thermal conducting film, a thermal insulating film, a coolant, a coolant circulator, an energy cell interconnect interrupt, or a combination thereof.

Embodiment 22. The stored energy module of embodiment 5, wherein the housing further comprises a high amp connector, a charge connector, a maintenance connector, or a combination thereof.

Embodiment 23. An integrated stored power system comprising: a coulometric capacity of at least 50 amp hours to not greater than 1000 amp hours at a discharge rate of 26.4 V DC, such as at least 150 amp hours, at least 200 amp hours, at least 250 amp hours, or at least 300 amp hours.

Embodiment 24. The integrated stored power system of embodiment 23, further comprising a Max Pulse Discharge of at least 2000 amps, such as at least 3000 amps, or at least 4000 amps.

Embodiment 25. The integrated stored power system of embodiment 24, wherein the Max Pulse Discharge is per a cycle life of at least one second to not greater than 10 seconds at a 150 amp discharge.

Embodiment 26. The integrated stored power system of embodiment 25, comprising a coulometric capacity of 150 amp hours at a discharge rate of 26.4 V DC and a Max Pulse Discharge of 3000 amps per cycle life of at least 10 seconds at a 150 amp discharge.

Embodiment 27. The integrated stored power system of embodiment 23, comprising a stored energy module.

Embodiment 28. The integrated stored power system of embodiment 27, comprising a plurality of stored energy modules, such as at least 2 stored energy modules, or at least 3 stored energy modules.

Embodiment 29. The integrated stored power system of embodiment 27, wherein the stored energy modules is according to any one of embodiments 1 to 22.

Embodiment 30. An energy storage module or a stored power system adapted to produce a flat discharge curve inversely proportional to the state of charge in the energy storage module or the stored power system.

Embodiment 31. The energy storage module or a stored power system of embodiment 30, wherein the discharge profile comprises a change in voltage (voltage delta) that is not greater than 20% of the average voltage during discharge, such as not greater than 18%, not greater than 16%, not greater than 15%, not greater than 14%, or not greater than 13% of the average voltage during discharge.

Embodiment 32. The energy storage module or a stored power system of embodiment 30, wherein the discharge profile comprises peak amperage spike of not greater than 600% of the average current draw, such as not greater than 550%, not greater than 500%, not greater than 495%, or not greater than 490% of the average current draw.

Embodiment 33. An energy storage module or stored power system as described herein.

### EXAMPLES

### Example 1—Single Energy Module Testing

An individual energy storage module embodiment (electrochemical), as described herein, and as shown in FIG. 1 was performance tested at powering the operation of a heavy vehicle, in particular an armored combat vehicle equipped with a missile system and active radar. The individual energy storage module embodiment comprised a lithium iron phosphate composition. The individual energy storage module embodiment was configured to provide 50 amp hours (Ah) at a voltage of 26.4 Volts DC (1.32 kWh) and have a maximum pulse discharge greater than 1000 amps per 10 second and a cycle life at 160 amps discharge (100% DOD) of greater than 1000 cycles. The operating temperature was in a range of −30° C. to 55° C. while the storage temperature prior to testing was in a range of −40° C. to 60° C. The power output of the individual energy storage module embodiment was not less than 20,800 W/kg. The total the weight of the individual energy storage module embodiment was less 30 lbs., specifically only 16.8 lbs. and had dimensions of 13.4 inches (H) by 4.4 inches (W) by 10.4 inches (L). For the test, the individual energy storage module was mounted inside a commercially available hand held, hard plastic case (Pelican 1200). The comparative power system was the existing original equipment, state-of-the art, electrochemical battery power system for the armored combat vehicle (Chaparral Missile Systems) which comprised eight, 80 Amp hour SLA batteries that each weighed 102.3 lbs. for a total weight of 818.4 lbs for the system.

Surprisingly and beneficially, the individual energy storage module embodiment was able to alone successfully power the combat vehicle, including powering the active radar system and provide rapid articulation of the vehicle's turret during the duration of the test (15 minutes). Notably, the energy storage module embodiment would have been capable of providing power to the vehicle for longer as the end of life of the module had not yet been reached. FIG. 3 shows the discharge profile of the individual electrochemical energy storage module embodiment. As shown by the discharge profile, the sample individual electrochemical energy storage module embodiment was able to provide a surprisingly flat profile of an average voltage of 25.04 V with a change in voltage (“voltage delta”) of only 3.16 V. Further, the average current draw during the test was 133 amps with peak amperage spikes of less than 650 amps during the rapid turret articulation. Significantly and beneficially, the individual energy storage module embodiment was able to provide 12 times the energy density of the comparative battery power system but occupied only 1/20 of the total foot print (volume) of the comparative battery power system.

### Example 2—Integrated Stored Power System (Electrochemical Only)

A single integrated stored power system embodiment, as shown in FIG. 2., which comprised a total of three individual energy storage module embodiments (all electrochemical modules) as shown in FIGS. 1A and 1B. and described in Example 1 were prepared. The three individual energy storage module embodiments were mounted in the support framework (“chassis”) and connected in parallel. The integrated stored power system embodiment was configured to provide 150 amp hours (Ah) at a voltage of 26.4 Volts DC (3.96 kWh) and a maximum pulse discharge of 3000 amps per 10 second cycle life at a 450 Ah discharge. The operating temperature for the integrated stored power system embodiment was in a range of −30° C. to 55° C. while the storage temperature was in a range of −40° C. to 60° C. The power output of the integrated stored power system embodiment was not less than 115,200 W/kg. The weight of the integrated stored power system was less than 95.0 lbs. and had dimensions of 15.28 inches (H) by 11.19 inches (W) by 20 inches (L).

The integrated stored power system embodiment has been successfully demonstrated and tested in the field.

### Example 3—Integrated Stored Power System (Hybrid—Electrochemical and Supercapacitor)

A single integrated stored power system embodiment (Hybrid—electrochemical and supercapacitor) is planned to be built and performance tested. The hybrid Integrated stored power system will comprise a combination of a plurality of individual power modules, such as two or three energy storage modules connected in parallel, that includes at least one electrochemical energy storage module (battery) and at least one electrostatic energy storage module (supercapacitor). Performance testing of the hybrid integrated stored power system is planned and expected to demonstrate surprisingly beneficial results.

What is claimed is:

1. A stored energy module comprising:
a coulometric capacity of at least 1.5 amp hours to not greater than 150 amp hours at a discharge rate of 26.4 V DC.

2. The stored energy module of claim 1, further comprising a Max Pulse Discharge of 1000 amps.

3. The stored energy module of claim 2, wherein the Max Pulse Discharge is per a cycle life of at least one second to not greater than 10 seconds at a 150 amp discharge.

4. The stored energy module of claim 3, comprising a coulometric capacity of 50 amp hours at a discharge rate of 26.4 V DC and a Max Pulse Discharge of 1000 amps per cycle life of at least 10 seconds at a 150 amp discharge.

5. The stored energy module of claim 1, further comprising an energy storage cell disposed inside a housing.

6. The stored energy module of claim 5, wherein a plurality of energy storage cells are disposed inside the housing.

7. The stored energy module of claim 5, wherein the energy storage cell comprises an electrochemical composition.

8. The stored energy module of claim 7, wherein the electrochemical composition comprises a lithium composition.

9. The stored energy module of claim 5, wherein the energy storage cell comprises an electrostatic storage element.

10. The stored energy module of claim 9, wherein the electrostatic storage element is a capacitor.

11. The stored energy module of claim 10, wherein the capacitor is a double layer capacitor.

12. The stored energy module of claim 5, wherein the energy storage cell is a cylindrical cell, a prismatic cell, a pouch cell, or a combination thereof.

13. The stored energy module of claim 5, wherein the housing further comprises a high amp connector, a charge connector, a maintenance connector, or a combination thereof.

14. An integrated stored power system comprising:
a coulometric capacity of at least 50 amp hours to not greater than 1000 amp hours at a discharge rate of 26.4 V DC.

15. The integrated stored power system of claim 14, further comprising a Max Pulse Discharge of at least 2000 amps, such as at least 3000 amps, or at least 4000 amps.

16. The integrated stored power system of claim 15, wherein the Max Pulse Discharge is per a cycle life of at least one second to not greater than 10 seconds at a 150 amp discharge.

17. The integrated stored power system of claim 16, comprising a coulometric capacity of 150 amp hours at a discharge rate of 26.4 V DC and a Max Pulse Discharge of 3000 amps per cycle life of at least 10 seconds at a 150 amp discharge.

18. An energy storage module or a stored power system adapted to produce a flat discharge curve inversely proportional to the state of charge in the energy storage module or the stored power system.

19. The energy storage module or a stored power system of claim 18, wherein the discharge profile comprises a change in voltage (voltage delta) that is not greater than 20% of the average voltage during discharge.

20. The energy storage module or a stored power system of claim 18, wherein the discharge profile comprises a peak amperage spike of not greater than 600% of the average current draw.
